(19) United States
(12) Patent Application Publication
(10) Pub. No.: US 2008/0230330 A1
(43) Pub. Date: Sep. 25, 2008

(54) BRAKING DEVICE HAVING A WEDGE MECHANISM

(75) Inventor: MICHAEL HERR, Nurnberg (DE)

Correspondence Address: Henry M. Feiereisen;Henry M. Feiereisen, LLC, Suite 4714, 350 Fifth Avenue, New York, NY, 10118, US

(73) Assignee: Siemens Aktiengesellschaft, Munchen (DE)

(21) Appl. No.: 12/050,582

(22) Filed: Mar. 18, 2008

(30) Foreign Application Priority Data
Mar. 20, 2007 (DE) 10 2007 013 421.7

(51) Int. Cl. F16D 55/22

(52) U.S. Cl. 188/72.7

(57) ABSTRACT

A braking device includes a brake block which can be actuated by a wedge mechanism which has first and second wedge elements. Each wedge element has at least one contact face beveled in the manner of a wedge, with the contact faces of the wedge elements opposing one another. The brake block is fitted to a side of one of the wedge elements which is remote from the contact face. The one wedge element can be moved in reciprocating fashion in a longitudinal direction relative to the other wedge element so that, owing to the wedge action of the beveled contact faces, the brake block moves in a transverse direction perpendicular to the longitudinal direction toward or away from the brake disk. At least one linear actuator, which is free from rotational movement and is mechanically connected to the one wedge element, moves the one wedge element back and forth in the longitudinal direction.

### CROSS-REFERENCES TO RELATED APPLICATIONS

This application claims the priority of German Patent Application, Serial No. 10 2007 013 421.7, filed Mar. 20, 2007, pursuant to 35 U.S.C. 119(a)-(d), the content of which is incorporated herein by reference in its entirety as if fully set forth herein.

### BACKGROUND OF THE INVENTION

The present invention relates to a braking device having a wedge mechanism

Nothing in the following discussion of the state of the art is to be construed as an admission of prior art.

U.S. Pat. No. 6,318,513, issued on Nov. 20, 2001, discloses an electromechanical brake, in particular for vehicles, having an electric motor which generates an actuation force and acts on at least one frictional element so as to press the latter, in order to bring about a frictional force, against a rotatable component of the brake which is to be braked. Placed between the component to be braked and the electric actuator is an arrangement which brings about the self-energization of the actuation force generated by the electric motor. The electric motor is connected to a (worm) gear to convert a rotational movement of the electric motor into the linear movement required for achieving the braking force. This process is complex.

It would therefore be desirable and advantageous to provide an improved to obviate prior art shortcomings and to allow movement of wedge elements relative to one another in a simple and yet reliable manner.

### SUMMARY OF THE INVENTION

According to one aspect of the present invention, a braking device includes a wedge mechanism having two wedge elements, each wedge element having at least one contact face beveled in the manner of a wedge, with the contact faces of the wedge elements opposing one another, a brake block actuated by the wedge mechanism for braking an element, with the brake block fitted to a contact-face-distal side of one of the wedge elements, wherein one wedge element is movable back and forth in a longitudinal direction relative to the other one of the wedge elements so that the brake block is able to move in a transverse direction perpendicular to the longitudinal direction toward or away from the element as a result of the wedge action of the beveled contact faces, and at least one non-rotatable linear actuator mechanically connected to the one wedge element to move the one wedge element back and forth in the longitudinal direction.

In accordance with the present invention, the provision of the non-rotatable linear actuator allows a direct implementation of the longitudinal or linear movement required for actuating the braking device. As a result, the need for converting a rotational movement to a linear movement is eliminated. The overall configuration of the braking device is considerably simplified, compact and of reduced weight, and requires little maintenance. There are fewer mechanically moving parts so that susceptibility to dirt and the degree of wear is reduced.

Recourse can be made to a series of established and available technical embodiments in order to implement the linear actuator. The exact configuration of the linear actuator depends on the requirements of the particular individual case, such as, for example, on the required length and speed of the adjustment path and/or on the required adjustment forces. For example, the linear actuator may be designed as a piezo drive. This can result in rapid reaction times and also large drive forces. As an alternative, the linear actuator may be designed as a drive based on electrically active polymer (EAP). This permits the implementation of large displacement distances. Other examples for implementation of the linear actuator involve a configuration in the form of a drive based on a shape memory alloy (SMA), e.g. a magnetic shape memory alloy (Magnetic Shape Memory=MSM), or a configuration in the form of a linear electromagnetic drive which represents an established and well-proven type of drive.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of an exemplary embodiment of a braking device according to the present invention in released position;

FIG. 2 is a schematic illustration of the braking device in braking position; and

FIG. 3 is a perspective illustration of another exemplary embodiment of a braking device according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

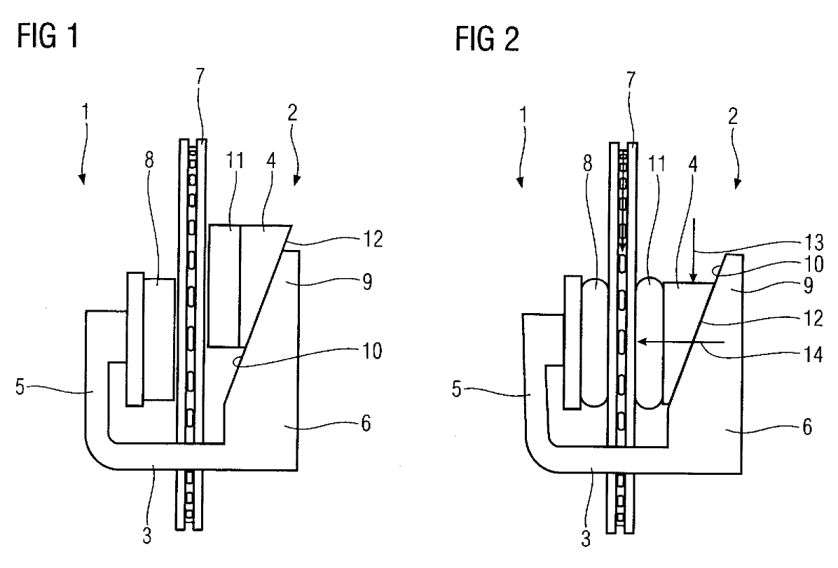

Turning now to the drawing, and in particular to FIG. 1, there is shown a schematic illustration of an exemplary embodiment of a braking device according to the present invention, generally designated by reference numeral 1. The braking device 1 includes a wedge mechanism 2. The basic mode of operation of such a wedge brake is apparent from the outline illustration in FIG. 1.

The wedge mechanism 2 comprises two wedge elements 3, 4. Wedge element 3 is hereby formed as a brake caliper which has two caliper arms 5, 6 to engage around a brake disk 7. The caliper arm 5 has one end which faces the brake disk 7 and is provided with a brake block 8. The other caliper arm 6 ends in a wedge portion 9 which has a beveled contact face 10 facing the brake disk 7.

The second wedge element 4 is arranged in the intermediate space between the brake disk 7 and the contact face 10. A brake block 11 is provided on a side of the second wedge element 4 which faces the brake disk 7. On its rear side which is distal to the brake disk 7, the wedge element 4 has a wedge-shaped rear profile with a contact face 12 which is likewise sloping. The contact faces 10, 12 are opposite one another. In the exemplary embodiment according to FIGS. 1 and 2, they even bear directly against one another. They each form an oblique plane with an inclination angle which is of the same magnitude but oriented in opposite directions.

When the braking device 1 is disengaged, as shown in FIG. 1, the brake blocks 8 and 11 do not make contact with the rotating brake disk 7. The wedge element 4 protrudes slightly beyond the intermediate space between the brake disk 7 and the contact face 10.

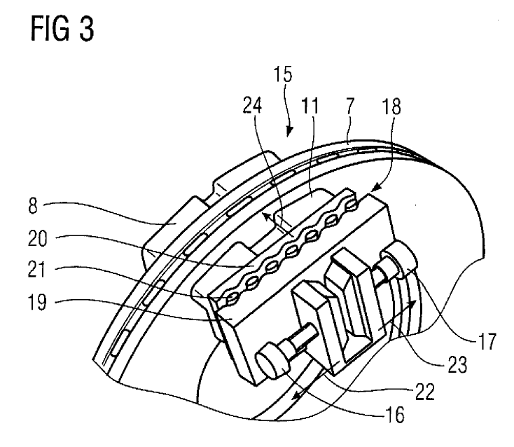

The wedge element 4 can be moved in reciprocating fashion in a longitudinal direction 13 by means of a linear actuator which is not illustrated in FIGS. 1 and 2 but shown in greater detail in FIG. 3. A forward movement predetermined by the linear actuator in the longitudinal direction 13 moves the wedge element 4 along the sloping contact face 10. Owing to the wedge action, the movement in the longitudinal direction 13 is accompanied by a movement in a transverse direction 14 perpendicular thereto. This transverse movement presses the wedge element 4 together with the brake block 11 against the brake disk 7. If the braking operation is initiated first of all by the linear actuator, the wedge element 4 is entrained owing to the rotation of the brake disk 7 and pulled further into the intermediate space between the brake disk 7 and the contact face 10 (FIG. 2). A self-energizing effect therefore occurs, permitting a very high braking force effect.

The braking device 1 is controlled electronically. Measured values of the current braking torque are detected and supplied to a control unit. The latter ensures that the correspondingly driven linear actuator holds the wedge element 4 (=brake wedge) precisely in the position in which the desired braking effect is produced.

FIG. 3 shows a further exemplary embodiment of a braking device according to the invention, generally designated by reference numeral 15. The braking device 15 has a wedge mechanism 18 which is driven by means of two linear actuators 16, 17 which are free from rotational movement. The basic mode of operation of the braking device 15 corresponds to that of the braking device 1. In particular, the braking effect of the braking device 15 is also based on the advantageous wedge effect.

However, the structure of the wedge mechanism 18 is somewhat different to that of the wedge mechanism 2 of the braking device 1 shown in FIGS. 1 and 2. The wedge mechanism 18 also comprises two wedge elements 19 and 20, but, in contrast to the embodiment in accordance with FIGS. 1 and 2, the wedge elements 19, 20 do not directly bear against one another. The wedge elements 19, 20 are formed as bearing halves of a rolling bearing and are only in contact with one another indirectly. Cylindrical or roller-shaped rolling bodies 21 are positioned between the wedge elements 19, 20. Each bearing half is provided with V-shaped grooves for holding and guiding the rolling bodies 21. The V-shaped grooves have obliquely running side walls against which the rolling bodies 21 bear. The oblique side walls form the wedge-shaped contact faces along which the wedge elements 19, 20 can be displaced relative to one another. Owing to the rolling bodies 21, the relative movement is not determined by sliding friction but by rolling friction in the exemplary embodiment in accordance with FIG. 3.

The grooves provided in the wedge elements 19, 20 for holding the rolling bodies 21 can also have a shape deviating slightly from the exact V-shape. In particular, the side walls can also be curved slightly. The braking force profile can thus be set in a particular manner.

In any case, the grooves have two side walls so that the rolling bodies 21 always move along oblique contact faces irrespective of which of the two longitudinal directions 22 and 23 the wedge elements 19, 20 are displaced in relation to one another. In the case of the braking device 15, the expedient wedge action therefore occurs during relative displacements in both longitudinal directions 22, 23. Owing to the wedge action, every such longitudinal displacement also gives rise to a movement component in a transverse direction 24 perpendicular thereto, so that the desired braking force effect is established. The braking device 15 consequently permits braking of the brake disk 7 which is equally satisfactory for both rotational directions.

The outer wedge element 19 is fixed in position in the exemplary embodiment of the braking device 15 in accordance with FIG. 3. Similarly to the exemplary embodiment in accordance with FIGS. 1 and 2, the wedge element 19 is mechanically connected to the brake block 8. In contrast, the inner wedge element 20 is mechanically coupled to the two linear actuators 16 and 17. The wedge element 20 can be moved in the longitudinal direction 22 or 23 synchronously with respect to the linear forward movement of the linear actuator 16 or 17. Since the linear actuators already bring about an axial movement in the longitudinal directions 22, 23, conversion from a rotational movement into a linear movement is not necessary. The linear actuators 16 and 17 are each designed as a high-precision piezo drive in the exemplary embodiment.

If the braking device 15 is in the position in which the contact-pressure force of the brake blocks 8, 11 against the brake disk 7 corresponds approximately to the desired value, the wedge element 20 is moved in reciprocating fashion in the longitudinal directions 22, 23 only in the range of a few micrometers by means of the control unit and the linear actuators 16, 17, said control unit also being provided in the case of this exemplary embodiment but not being illustrated in FIG. 3. The reaction time of the linear actuators 16 and 17 used is in the millisecond range.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A braking device, comprising:
a wedge mechanism including two wedge elements, each said wedge element having at least one contact face beveled in the manner of a wedge, with the contact faces of the wedge elements opposing one another;
a brake block actuated by the wedge mechanism for braking an element, said brake block fitted to a contact-face-distal side of one of the wedge elements, said one wedge element being movable back and forth in a longitudinal direction relative to the other one of the wedge elements so that the brake block is able to move in a transverse direction perpendicular to the longitudinal direction toward or away from the element as a result of the wedge action of the beveled contact faces; and
at least one non-rotatable linear actuator mechanically connected to the one wedge element to move the one wedge element back and forth in the longitudinal direction.

2. The braking device of claim 1, wherein the linear actuator is designed as a piezo drive.

3. The braking device of claim 1, wherein the linear actuator is designed as a drive based on electrically active polymer.

4. The braking device of claim 1, wherein the linear actuator is designed as a drive based on a shape memory alloy.

5. The braking device of claim 4, wherein the shape memory alloy is a magnetic shape memory alloy.

6. The braking device of claim 1, wherein the linear actuator is designed as a linear electromagnetic drive.

7. The braking device of claim 1, wherein the wedge elements abut one another.

8. The braking device of claim 1, wherein the wedge mechanism includes a rolling-contact assembly positioned between the wedge elements against oblique side walls of opposite grooves of the wedge elements, with the side walls defining the contact faces.

9. The braking device of claim 8, wherein the grooves have a substantially V-shaped configuration to define the oblique side walls.

10. The braking device of claim 8, wherein the side walls are curved.

11. The braking device of claim 8, wherein the actuator is mounted to an inner one of the wedge elements, with an outer one of the wedge elements being stationary.
